(19) United States
(12) Patent Application Publication
(10) Pub. No.: US 2020/0183903 A1
(43) Pub. Date: Jun. 11, 2020

(54) Database Performance Testing Utilizing a Virtual Database and Redirected Test Commands

(71) Applicant: IDERA, INC., Houston, TX (US)

(72) Inventors: Robert Wilkinson, Houston, TX (US); Scott Stone, Houston, TX (US)

(73) Assignee: IDERA, INC., Houston, TX (US)

(21) Appl. No.: 16/704,917

(22) Filed: Dec. 5, 2019

Related U.S. Application Data
(60) Provisional application No. 62/777,472, filed on Dec. 10, 2018.

(51) Int. Cl. G06F 16/21; G06F 11/34; G06F 11/14; G06F 16/25

(52) U.S. Cl. CPC G06F 16/217; G06F 11/3466; G06F 2201/84; G06F 16/256; G06F 11/1451

(57) ABSTRACT

A database performance testing system and non-transitory, computer readable medium utilizes a virtual database system to test a production-level database without interfering with operations of the production-level database by redirecting test commands to a backup database. By incorporating the virtual database system into a production-level database test, the database performance testing system and non-transitory, computer readable medium is able to overcome technical and resource obstacles of testing against a production-level database. The database performance testing system also includes a database management system that issues a test command to a production-level database. However, the virtual database system intercepts the test command and redirects the test command to a backup database, which is an equivalent of the production-level database. The test results returned by the backup database are the same results that would result from the production-level database without interfering with operations of the production-level database.

### CROSS-REFERENCE TO RELATED APPLICATION

This application claims the benefit under 35 U.S.C. § 119(e) and 37 C.F.R. § 1.78 of U.S. Provisional Application No. 62/777,472, filed Dec. 10, 2018, which is incorporated by reference in its entirety.

### BACKGROUND OF THE INVENTION

### Field of the Invention

The present invention relates in general to the field of database systems, and more specifically to a system and method for utilizing a virtual database, redirected database test commands, and live data to perform database performance testing.

### Description of the Related Art

Database systems generally include a database management system and database files. Database management systems control and coordinate access to the database files. Database systems are used to store data in a data processing system, such as a computer system, with the data being organized such that the data can be accessed, managed, and updated easily. For example, data may be organized in a structured database such as DB, DB2, SQL Server, Sybase, and the like.

Database systems often change on a regular basis. For example, changes to the database system include implementing recommendations for optimization from third-party tools, updates to correct issues or enable compatibility with other software and hardware, and application enhancements. Changes to a database system can potentially impact performance of the database system, such as impacting storage efficiency, access times, and compatibility. Changes also have the potential of inadvertently introducing errors. Accordingly, database systems are often regularly tested to assess the impact of such changes. Testing each minor change independently can be costly in terms of time and resources.

### SUMMARY

In one embodiment, a method of utilizing a virtual database system to perform database equivalent production-level database testing on a backup database includes creating the backup database. The method further includes executing code, stored in a memory, with one or more processors to cause the virtual database system to perform mounting the backup database by the virtual database system and intercepting, with the virtual database system, a test command directed to the production-level from a database management system (DBS). The test command correlates with a test request formulated to derive performance information about the production-level database. The method further includes executing the code to perform executing by the virtual database system the intercepted test command against the backup database and receiving returned results from the backup database responsive to the test request. The method also includes utilizing the returned results.

In another embodiment, a system to perform database equivalent production-level database testing on a backup database includes a virtual database system coupled to the backup database. The virtual database system is configured to mount the backup database by the virtual database system and intercept, with the virtual database system, a test command directed to the production-level from a database management system (DBS). The test command correlates with a test request formulated to derive performance information about the production-level database. The virtual database system is further configured to execute the intercepted test command against the backup database, receive returned results from the backup database responsive to the test request, and transmit the returned results of utilize the returned results for evaluation of the production-level database.

In a further embodiment, a non-transitory, computer readable medium includes code stored therein and executable by one or more processors to utilize a virtual database system to perform database equivalent production-level database testing on a backup database. Operations performed by the code executing by the one or more processors include mounting the backup database by the virtual database system and intercepting, with the virtual database system, a test command directed to the production-level from a database management system (DBS). The test command correlates with a test request formulated to derive performance information about the production-level database. The operations further include executing by the virtual database system the intercepted test command against the backup database, receiving returned results from the backup database responsive to the test request, and utilizing the returned results.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a database performance testing system that includes a virtual database system and redirected production-level database test commands.

FIG. 2 depicts a database performance testing process utilizing a virtual database system to redirect production-level database test commands.

FIG. 3 depicts an exemplary computer system.

### DETAILED DESCRIPTION

A database performance testing system and method utilizes a virtual database system to test a production-level database without interfering with operations of the production-level database by redirecting test commands to a backup database. By incorporating the virtual database system into a production-level database test, the database performance testing system and method is able to overcome technical and resource obstacles of testing against a production-level database. By utilizing a virtual database system, the database performance testing system and method can also avoid the overhead expenses of creating and hosting a copy of the production-level database solely for performance testing purposes. Additionally, once the virtual database system is active, performance testing can occur on demand and achieve equivalent test results relative to testing a production-level database.

Replicating a production-level database to ensure receipt of accurate test results is often not technically feasible, is too costly in terms of time and resources, and/or is too slow such that by the time the replica database is created, the production-level database has already changed. Live testing in production environments can be risky and costly due to, for example, unexpected problems and potentially damaging or rendering the production-level database unusable for some period of time. A “production-level database” is a database that is available for actual day-to-day activity use.

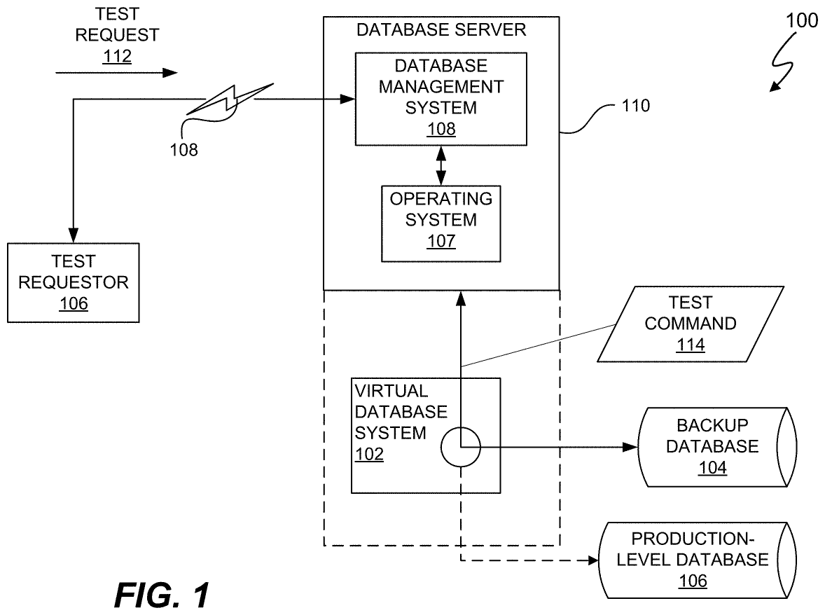

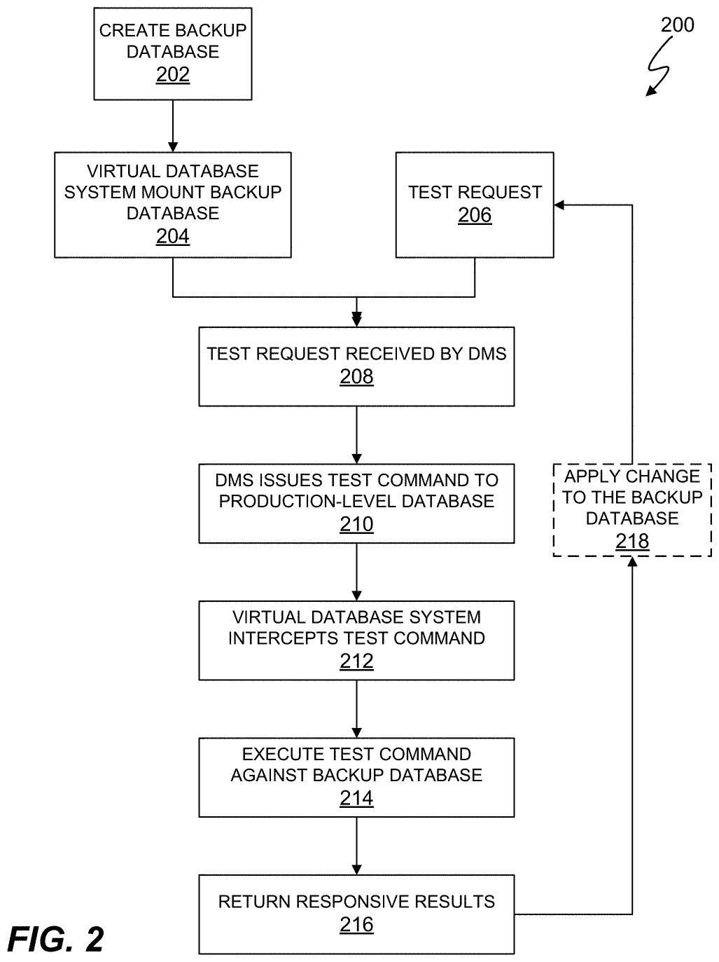

FIG. 1 depicts an exemplary database performance testing system 100 that includes a virtual database system 102. FIG. 2 depicts an exemplary database performance testing process 200 by which the database performance testing system 100 utilizes the virtual database system 102 to perform database equivalent production-level database testing on a backup database 104. In at least one embodiment, the backup database 104 is an exact replica or an equivalent of a production-level database 106 that is updated by the virtual database system 102 on an ongoing basis to maintain synchronization with the production-level database 106. Thus, the virtual database system 102 provides equivalent testing results relative to testing on the production-level database 106.

Referring to FIGS. 1 and 2, operation 202 creates the backup database 104. In at least one embodiment, the backup database 104 is created as described in U.S. Patent Publication No. 20110004586 (referred to herein as the “VDB Application,” which is hereby incorporated by reference in its entirety. Peripheral files (not shown), such as a log cache file and data cache file, may also be created as described in the VDB Application. The VDB Application discloses utilizing a virtual database for recovery of a production-level database. In operation 204, the virtual database system 102 mounts the backup database 104. In at least one embodiment, operations 202 and 204 are performed by a user that installs the virtual database system 102 and couples the virtual database system 102 to the database management system 108. The database management system 108 is installed on a database server 110. The physical location of the virtual database system 102 is a matter of design choice. For example, the virtual database system 102 can be installed on the database server 110 as indicated by the dashed perimeter lines or installed on a separate computer system (not shown) in communication with the database server 110. In at least one embodiment, the presense of the virtual database system 102 is unknown to the database management system 108 and the test requestor 106.

Testing begins in operation 206 when the test requestor 106 issues a test request 112 that is received by the database management system (DMS) 108 in operation 208. In at least one embodiment, the test requestor 106 is a machine, such as a client computer system, that executes any program that can generate a test request 112, to the database management system 108, that is intended for the production-level database 106 and formulated to derive performance information about the production-level database 106. Examples of test requestor 106 include a client computer system executing a SQL Server Management Studio application or Microsoft Operations Management Suite application which are both used to attach and execute SQL requests against databases. The particular test request 112 is a matter of design choice. For example, the test request 112 can be formulated using conventional techniques to cause the database performance testing system 100 to:

1. Obtain and, in at least one embodiment, also display, measured performance improvement metrics in conjunction with database tuning or database configuration changes.

2. Concurrently evaluate several changes to the production-level database 106 and obtain results for each change.

In operation 210, the database management system 108 issues to the production-level database 106 a test command 114 that correlates with and is responsive to the test request 112. In at least one embodiment, the database management system 108 issues the test command via an operating system 107. In operation 212, the virtual database system 102 intercepts the test request 112 and in operation 214 executes the test command against the backup database 104. The backup database 104 and database server 110 return test results responsive to the test request 112 to the test requestor 106 for, for example, display, evaluation, comparison, reformulation of a future test request 112, etc.

In at least one embodiment, the backup database 104 is a snapshot in time of the production-level database and not a continuously synchronized replica. Since the backup database 104 is the equivalent of the production-level database 106 or may include changes made or not yet made to the production-level database 106, the test results from the backup database 104 are the results that would have been obtained by issuing the test command 114 to the production-level database 106. In at least one embodiment, the obtained test results characterize performance of the production-level database 106. Test request 112 can be formulated to characterize any type of performance of the production-level database 106 such as, testing a state of the production-level database 106 or testing performance against multiple query formulations, such as structured query language (SQL) statements, to determine a preferred query formulation. The database performance testing process 200 then repeats starting at operation 206 to respond to a subsequent test request 112. In at least one embodiment, the test results serve as a baseline performance measure of the production-level database 106 to assess performance impacts of current or prospective changes to the production-level database 106. The particular changes are a matter of design choice, such as changing the way data in a table of the production-level database 106 is indexed, adding or deleting portions of the production-level database 106, or reorganizing the production-level database 106.

To assess a performance impact of a change or changes to the production-level database 106, optional operation 210 applies the change to the backup database 104 prior to applying the change or changes to the production-level database 106. The database performance testing process 200 then returns to operation 210 and reissues the test command to the production-level database 106 or awaits a repeat test request 112 at operation 206. Repeating operations 210-216 generates a performance measuring test result that can be compared by the test requestor 106 to the previously obtained baseline test result to assess the performance impact of the change.

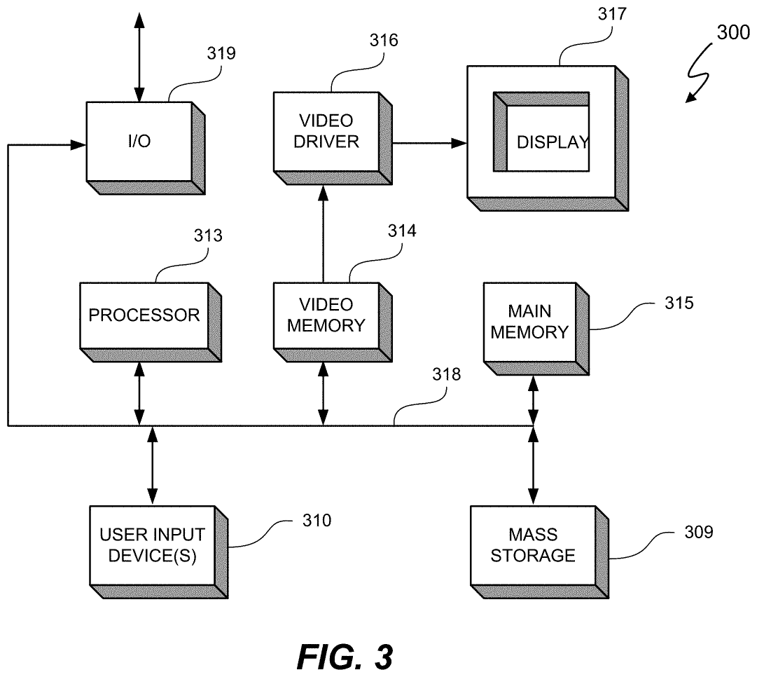

Embodiments of the database server 110 and test requestor 106 can be implemented on a computer system that includes specialized programming to perform the previously described operations of the database server 110 and the test requestor 106. The computer system 300 can be a dedicated computer system or a virtual, emulated system located in, for example, a cloud computing environment. Input user device(s) 310, such as a keyboard and/or mouse, are coupled to a bi-directional system bus 318. The input user device(s) 310 are for introducing user input to the computer system and communicating that user input to processor 313. The computer system of FIG. 3 generally also includes a non-transitory video memory 314, non-transitory main memory 315, and non-transitory mass storage 309, all coupled to bi-directional system bus 318 along with input user device(s) 310 and processor 313. The mass storage 309 may include both fixed and removable media, such as a hard drive, one or more CDs or DVDs, solid state memory including flash memory, and other available mass storage technology. Bus 318 may contain, for example, 32 of 64 address lines for addressing video memory 314 or main memory 315. The system bus 318 also includes, for example, an n-bit data bus for transferring DATA between and among the components, such as CPU 309, main memory 315, video memory 314 and mass storage 309, where “n” is, for example, 32 or 64. Alternatively, multiplex data/address lines may be used instead of separate data and address lines.

I/O device(s) 319 may provide connections to peripheral devices, such as a printer, and may also provide a direct connection to a remote server computer system via a telephone link or to the Internet via an ISP. I/O device(s) 319 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in a non-transient computer readable medium such as a flash memory, optical memory, magnetic memory, compact disks, digital versatile disks, and any other type of memory. The computer program is loaded from a memory, such as mass storage 309, into main memory 315 for execution. Computer programs may also be in the form of electronic signals modulated in accordance with the computer program and data communication technology when transferred via a network. In at least one embodiment, Java applets or any other technology is used with web pages to allow a user of test requestor 106 to make and submit test request 112.

The processor 313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 315 is comprised of dynamic random access memory (DRAM). Video memory 314 is a dual-ported video random access memory. One port of the video memory 314 is coupled to video amplifier 316. The video amplifier 316 is used to drive the display 317. Video amplifier 316 is well known in the art and may be implemented by any suitable means. This circuitry converts pixel DATA stored in video memory 314 to a raster signal suitable for use by display 317. Display 317 is a type of monitor suitable for displaying graphic images. The computer system described above is for purposes of example only.

Thus, the database performance testing system and method utilizes a virtual database system to assess a production-level database by redirecting test commands to a backup database without interfering with operations of the production-level database. The database performance testing system and method utilizing the virtual database system are able to overcome technical and resource obstacles of testing against a production-level database. The database performance testing system also includes a database management system that issues a test command to a production-level database. However, the virtual database system intercepts the test command and redirects the test command to a backup database, which is an equivalent of the production-level database. The test results returned by the backup database are the same results that would result from the production-level database without interfering with operations of the production-level database.

Although embodiments have been described in detail, it should be understood that various changes, substitutions, and alterations can be made hereto without departing from the spirit and scope of the invention as defined by the appended claims.

What is claimed is:

1. A method of utilizing a virtual database system to perform database equivalent production-level database testing on a backup database, the method comprising:
executing code, stored in a memory, with one or more processors to cause the virtual database system to perform:
mounting the backup database by the virtual database system;
intercepting, with the virtual database system, a test command directed to the production-level from a database management system (DBS), wherein the test command correlates with a test request formulated to derive performance information about the production-level database;
executing by the virtual database system the intercepted test command against the backup database; and
receiving returned results from the backup database responsive to the test request; and
utilizing the returned results.

2. The method of claim 1 wherein formulated to derive performance information about the production-level database comprises formulated to perform one or more of:
obtaining measured performance improvement metrics in conjunction with tuning or configuration changes of the production-level database and
concurrently evaluating several changes to the production-level database and obtain results for each change
characterizing any type of performance of the production-level database including one or more of:
testing a state of the production-level database; and
testing performance against multiple query formulations to determine a preferred query formulation.

3. The method of claim 1 wherein the backup database is a snapshot in time of the production-level database and not a continuously synchronized replica.

4. The method of claim 1 wherein the backup database is either an equivalent of the production-level database or the backup database includes changes not made to the production-level database.

5. The method of claim 1 wherein the returned results comprise a baseline performance measure of the production-level database to assess performance impacts of current or prospective changes to the production-level database.

6. The method of claim 1 wherein utilizing the returned results comprises one or more of:
evaluating the results to evaluate the production-level database;
comparing the results with previous results;
reformulating a future test request; and
applying one or more changes to the production level database including one or more of:
changing a way data in a table of the production-level database is indexed;
adding or deleting portions of the production-level database; and
reorganizing the production-level database.

7. The method of claim 6 further comprising:
prior to applying any of the one or more changes to the production level database, applying one or more of the changes to the virtual database.

8. The method of claim 1 further comprising:
causing the DBS to issue the test command to the production level database.

9. A system to perform database equivalent production-level database testing on a backup database, the system comprising:
a virtual database system coupled to the backup database, wherein the virtual database system is configured to:
mount the backup database by the virtual database system;
intercept, with the virtual database system, a test command directed to the production-level from a database management system (DBS), wherein the test command correlates with a test request formulated to derive performance information about the production-level database;
execute the intercepted test command against the backup database;
receive returned results from the backup database responsive to the test request; and
transmit the returned results of utilize the returned results for evaluation of the production-level database.

10. The system of claim 10 wherein formulated to derive performance information about the production-level database comprises formulated to perform one or more of:
obtain measured performance improvement metrics in conjunction with tuning or configuration changes of the production-level database and
concurrently evaluate several changes to the production-level database and obtain results for each change
characterize any type of performance of the production-level database including one or more of:
test a state of the production-level database; and
test performance against multiple query formulations to determine a preferred query formulation.

11. The system of claim 10 wherein the backup database is a snapshot in time of the production-level database and not a continuously synchronized replica.

12. The system of claim 10 wherein the backup database is either an equivalent of the production-level database or the backup database includes changes not made to the production-level database.

13. The system of claim 10 wherein the returned results comprise a baseline performance measure of the production-level database to assess performance impacts of current or prospective changes to the production-level database.

14. The system of claim 10 wherein utilize the returned results comprises one or more of:
evaluate the results to evaluate the production-level database;
compare the results with previous results;
reformulate a future test request; and
apply one or more changes to the production level database including one or more of:
change a way data in a table of the production-level database is indexed;
add or delete portions of the production-level database; and
reorganize the production-level database.

15. The system of claim 14 further comprising:
prior to applying any of the one or more changes to the production level database, apply one or more of the changes to the virtual database.

16. The system of claim 10 wherein the virtual database system is further configured to:
cause the DBS to issue the test command to the production level database.

17. A non-transitory, computer readable medium comprising code stored therein and executable by one or more processors to utilize a virtual database system to perform database equivalent production-level database testing on a backup database with operations comprising:
mounting the backup database by the virtual database system;
intercepting, with the virtual database system, a test command directed to the production-level from a database management system (DBS), wherein the test command correlates with a test request formulated to derive performance information about the production-level database;
executing by the virtual database system the intercepted test command against the backup database;
receiving returned results from the backup database responsive to the test request; and
utilizing the returned results.

18. The non-transitory, computer readable medium of claim 17 wherein formulated to derive performance information about the production-level database comprises formulated to perform one or more of:
obtaining measured performance improvement metrics in conjunction with tuning or configuration changes of the production-level database and
concurrently evaluating several changes to the production-level database and obtain results for each change
characterizing any type of performance of the production-level database including one or more of:
testing a state of the production-level database; and
testing performance against multiple query formulations to determine a preferred query formulation.

19. The non-transitory, computer readable medium of claim 17 wherein the backup database is a snapshot in time of the production-level database and not a continuously synchronized replica.

20. The non-transitory, computer readable medium of claim 17 wherein the backup database is either an equivalent of the production-level database or the backup database includes changes not made to the production-level database.

21. The non-transitory, computer readable medium of claim 17 wherein the returned results comprise a baseline performance measure of the production-level database to assess performance impacts of current or prospective changes to the production-level database.

22. The non-transitory, computer readable medium of claim 17 wherein utilizing the returned results comprises one or more of:
evaluating the results to evaluate the production-level database;
comparing the results with previous results;
reformulating a future test request; and
applying one or more changes to the production level database including one or more of:
changing a way data in a table of the production-level database is indexed;
adding or deleting portions of the production-level database; and
reorganizing the production-level database.

23. The non-transitory, computer readable medium of claim 22 wherein the code is further executable by the one or more processors to perform:
prior to applying any of the one or more changes to the production level database, applying one or more of the changes to the virtual database.

24. The non-transitory, computer readable medium of claim 17 wherein the code is further executable by the one or more processors to perform:
causing the DBS to issue the test command to the production level database.
